(19) United States
(12) Patent Application Publication
(10) Pub. No.: US 2003/0026053 A1
(43) Pub. Date: Feb. 6, 2003

(54) Circuit protection device

(76) Inventors: James Toth, San Carlos, CA (US); Naofumi Miyasaka, Narita (JP); Matthew P. Galla, San Francisco, CA (US)

Correspondence Address: TYCO ELECTRONICS CORPORATION, MAIL STOP R20/2B, 307 CONSTITUTION DRIVE, MENLO PARK, CA, 94025, US

(21) Appl. No.: 09/923,598

(22) Filed: Aug. 6, 2001

(51) Int. Cl. H02H 5/04; H02H 1/00

(52) U.S. Cl. 361/106; 361/126

(57) ABSTRACT

A circuit protection device suitable for welding to a battery terminal or other substrate without adverse affects caused by weld splatter. The device contains a laminar PTC resistive element, e.g. made from a conductive polymer composition, sandwiched between first and second electrodes. A first electrical lead has a first attachment portion having an attachment surface which is attached to the first electrode, a first connection portion which can be connected to an electrical circuit and is spaced away from the PTC element, and a first barrier portion. The first barrier portion is positioned on the first lead between the first attachment and first connection portions and extends toward the second electrode. During resistance welding, the barrier portion prevents weld splatter from contacting the PTC resistive element.

### BACKGROUND OF THE INVENTION

1. Field of the Invention

This invention relates to a circuit protection device, in particular, a circuit protection device comprising a conductive polymer suitable for welding onto a battery or other substrate.

2. Introduction to the Invention

Circuit protection devices exhibiting a positive temperature coefficient of resistance (PTC behavior) are well-known. Such devices generally comprise a PTC resistive element composed of a conductive polymer composition. First and second electrodes, e.g. in the form of metal sheets or foils, are attached to the conductive polymer to allow electrical connection to the device. The use of circuit protection devices to protect batteries from overcurrent and overtemperature conditions is also well-known. See, for example, U.S. Pat. Nos. 4,255,698 (Simon), 4,973,936 ((Dimpault-Darcy et al.), 5,801,612 (Chandler et al.), and 6,114,942 (Kitamoto et al.), and Japanese Utility Model Application No. 4-75287 (filed Oct. 29, 1992), the disclosures of which are incorporated herein by reference. In these applications, a PTC device is connected in series with a battery terminal. During normal operation the PTC device is in a low resistance, low temperature condition (depending on circuit conditions, for example from room temperature to 40° C.). On exposure to a very high current that may develop, for example, due to a short circuit, or exposure to a high temperature that may develop, for example, due to excessive charging and produce temperatures of 60 to 130° C., the device switches into a high resistance, high temperature condition, thus decreasing the current through the battery to a low level and protecting any components in contact with the battery.

A conventional circuit protection device having one preferred geometry for battery protection is shown in FIGS. 1 and 2. In this construction, commonly known as a strap device, the PTC element 3 is sandwiched between two electrodes 9, 11 to form a “chip”, and the chip is attached, e.g. by solder, to first and second planar metal electrical leads 21, 31 which extend from opposite ends of the chip. The lead at one end of this device can be electrically connected to a battery cell and the lead at the other end can be electrically connected to either a second battery cell or another component such as a circuit board or battery pack terminal. In this the way the device can act as both a protection device and an interconnection device.

The device is usually attached to the battery cell or other component by resistance-or spot-welding to the metal can of the battery or a metal tab on the component. During resistance welding an extremely high current is passed between two pieces of metal. This high current causes local heating at the metal-metal interface that is sufficient to melt the surface of both pieces of metal and cause them to be joined, i.e. “weld”. One problem with a resistance weld is that the high energy of the process can cause small bits of molten metal to be expelled from the site of the weld. This phenomenon is commonly known as weld splatter.

Weld splatter can be especially problematic when attaching a strap device to a cell because the molten metal can significantly interfere with the performance of the PTC device if it comes in contact with the chip. The metal can solidify when it hits the edge of the PTC element and can remain in contact with the first and second electrodes, effectively shorting out the chip. Because the device functions by going into a high resistance state when a fault occurs, a low resistance short across it prevents normal functioning. Alternatively the very high temperature of the molten metal can burn, char, or otherwise damage the conductive polymer portion of the device and cause it to fail.

Strap devices are typically wrapped with a piece of polymeric tape as shown in FIG. 3. This tape performs several functions, including environmental protection, and can provide some protection from weld splatter. However it is known that if the bits of molten metal from the weld splatter are sufficiently hot, they can burn through the tape. Weld splatter can also directly hit the PTC element by entering the gap between the tape and the electrical lead

### BRIEF SUMMARY OF THE INVENTION

We have discovered that it is possible to form the metal lead of a strap device in such a way to prevent weld splatter from contacting and potentially damaging a PTC element. An obstruction or barrier can be formed in or added to the lead in an area between the spot weld and the PTC element. This obstruction acts as a shield to prevent weld splatter from hitting the edge of the PTC element and damaging it. The obstruction could be formed in or added to the individual leads before reflow attachment to the PTC chip or could be formed in or added to the final device after assembly.

In a first aspect this invention provides a circuit protection device comprising

(1) a laminar PTC resistive element having first and second major surfaces and a thickness t;

(2) a first electrode attached to the first surface of the PTC element;

(3) a second electrode attached to the second surface of the PTC element; and

(4) a first electrical lead comprising

(a) a first attachment portion having an attachment surface which is attached to the first electrode,

(b) a first connection portion which can be connected to an electrical circuit and is spaced away from the PTC element, and

(c) a first barrier portion which (i) is positioned on the first lead between the first attachment and first connection portions, (ii) extends toward the second electrode, and (iii) has a height x.

In a second aspect, the invention provides a circuit protection device according to the first aspect of the invention, which further comprises

(5) a second electrical lead comprising

(a) a second attachment portion having an attachment surface which is attached to the second electrode,

(b) a second connection portion which can be connected to an electrical circuit and is spaced away from the PTC element, and

(c) a second barrier portion which (i) is positioned on the second lead between the second attachment and second connection portions, and (ii) extends toward the first electrode,

said first barrier portion being designed to block weld splatter between the first connection portion and the PTC element and said second barrier portion being designed to block weld splatter between the second connection portion and the PTC element.

In a third aspect, the invention provides a battery assembly comprising

(A) a circuit protection device according to the first aspect of the invention; and

(B) a battery comprising a terminal, said terminal being welded to the first connection portion.

### BRIEF DESCRIPTION OF THE DRAWINGS

The invention is illustrated by the drawings in which FIG. 1 is a perspective view of a conventional circuit protection device;

FIG. 2 is a cross-sectional view along line II-II of FIG. 1;

FIG. 3 is a perspective view of another conventional circuit protection device;

FIG. 4 is a cross-sectional view along line IV-IV of FIG. 3;

FIG. 5 is a perspective view of a circuit protection device of the invention;

FIG. 6 is a cross-sectional view along line VI-VI of FIG. 5;

FIG. 7 is a perspective view of another circuit protection device of the invention;

FIG. 8 is a cross-sectional view along line VIII-VIII of FIG. 7, also showing a battery assembly of the invention;

FIG. 9 is a perspective view of another circuit protection device of the invention;

FIG. 10 is a cross-sectional view along line X-X of FIG. 9;

FIGS. 11 and 12 are perspective views of other circuit protection devices of the invention;

FIG. 13 is a cross-sectional view along line XIII-XIII of FIG. 12;

FIG. 14 is a perspective view of a circuit protection device of the invention;

FIG. 15 is a cross-sectional view along line XV-XV of FIG. 14;

FIG. 16 is a perspective view of another circuit protection device of the invention; and

FIG. 17 is a cross-sectional view along line XVII-XVII of FIG. 16.

### DETAILED DESCRIPTION OF THE INVENTION

The circuit protection device of the invention comprises a laminar resistive element composed of a PTC material, e.g. a conductive polymer composition or a ceramic. Such conductive polymer compositions comprise a polymeric component, and dispersed therein, a particulate conductive filler such as carbon black or metal. Conductive polymer compositions are described in U.S. Pat. Nos. 4,237,441 (van Konynenburg et al.), 4,304,987 (van Konynenburg), 4,514,620 (Cheng et al.), 4,534,889 (van Konynenburg et al.), 4,545,926 (Fouts et al.), 4,724,417 (Au et al.), 4,774,024 (Deep et al.), 4,935,156 (van Konynenburg et al.), 5,049,850 (Evans et al.), 5,378,407 (Chandler et al.), 5,451,919 (Chu et al.), 5,582,770 (Chu et al.), 5,747,147 (Wartenberg et al.), and 5,801,612 (Chandler et al.), and U.S. patent applications Ser. Nos. 09/364,504 (Isozaki et al., filed Jul. 30, 1999) and 09/387,275 (Chen et al., filed Aug. 31, 1999). The disclosure of each of these patents and applications is incorporated herein by reference. Conductive polymer compositions are preferred due to lower resistivity and easier manufacturability than ceramic compositions.

The composition used in the device exhibits positive temperature coefficient (PTC) behavior, i.e. it shows a sharp increase in resistivity with temperature over a relatively small temperature range. The term “PTC” is used to mean a composition or device that has an R₁₄ value of at least 2.5 and/or an R₁₀₀ value of at least 10, and it is preferred that the composition or device should have an R₃₀ value of at least 6, where R₁₄ is the ratio of the resistivities at the end and the beginning of a 14° C. range, R₁₀₀ is the ratio of the resistivities at the end and the beginning of a 100° C. range, and R₃₀ is the ratio of the resistivities at the end and the beginning of a 30° C. range.

The PTC resistive element has a thickness t, which varies depending on the specific application and the resistivity of the conductive polymer composition. In general, t is 0.051 to 2.5 mm (0.002 to 0.100 inch), preferably 0.08 to 2.0 mm (0.003 to 0.080 inch), particularly 0.13 to 0.51 mm (0.005 to 0.020 inch), e.g. 0.13 mm or 0.25 mm (0.005 inch or 0.010 inch).

Devices of the invention comprise first and second laminar electrodes, preferably metal foil electrodes, with the laminar conductive polymer resistive element sandwiched between them so that the first electrode is secured to the first face of the laminar element, i.e. the first major surface, and the second electrode is secured to the second face of the laminar element, i.e. the second major surface. Particularly suitable foil electrodes have at least one surface that is microrough, e.g. electrodeposited, preferably electrodeposited nickel or copper. Appropriate electrodes are disclosed in U.S. Pat. Nos. 4,689,475 (Matthiesen), 4,800,253 (Kleiner et al.), and 5,874,885 (Chandler et al.) and copending U.S. application Ser. No. 08/816,471 (Chandler et al., filed Mar. 13, 1997), the disclosure of each of which is incorporated herein by reference. The electrodes may be attached to the resistive element by compression-molding, nip-lamination, or any other appropriate technique. The electrodes may be secured directly to the resistive element or attached by means of an adhesive or tie layer. For some devices it is preferred that the first and second laminar electrodes comprise metal layers formed by directly depositing metal onto the PTC resistive element, e.g. by plating, sputtering, or chemical deposition.

Circuit protection devices of the invention comprise a first electrical lead, and preferably a second electrical lead, as well, which may be the same or different from the first electrical lead. Such leads are used to connect the device to a substrate, e.g. a battery, and generally extend beyond part of the edge of the PTC element in the form of straps. The first lead is attached to the first electrode and the second lead is attached to the second electrode by any suitable method, e.g. solder or conductive adhesive. Depending on the application, the ease of attachment, or thermal management, the lead may be positioned so that relatively little or substantially all of the electrode which it contacts is covered.

The first electrical lead comprises three sections: a first attachment portion, a first connection portion, and a first barrier portion which is positioned on the first lead between the first attachment and connection portions. The first attachment portion is the section which is attached to the first electrode by an attachment surface, and it is the section which covers at least part of the first electrode. The first connection portion is spaced away from the PTC element, and is used to make electrical connection to the substrate, e.g. by means of a weld. The first barrier portion is the section which provides protection against weld splatter. It comprises a barrier which extends from the plane of the first lead toward the second electrode, i.e. it protrudes into the space through which the weld splatter would move in order to contact the PTC element. The first barrier portion has a height x, which is sufficient to prevent weld splatter from contacting the PTC element. In general, x is 0.05 to 0.51 mm (0.002 to 0.02 inch), although it can be substantially greater, e.g. 1 mm (0.04 inch). The height of the first barrier portion x is preferably at least 0.5 t, particularly at least 0.8 t, preferably at least t.

The first lead generally comprises a single piece of generally flat metal, e.g. nickel having a thickness of 0.13 mm (0.005 inch). The barrier can be formed from and as part of the single piece of metal, or it can be added to the surface of the metal. A preferred barrier portion is one in which the barrier is in the shape of an indentation or bend in the lead, e.g. having a semi-circular or triangular (notched) shape. Alternatively, the first lead could be bent out of its original plane to form a discontinuity which protects the edge of the PTC element from weld splatter. In general, such a bend is designed so that the first connection portion of the first lead is in approximately the same plane as the second lead, if present. Another approach is to cut, punch, etch, or otherwise remove a small section out of the plane of the first lead to form a raised cut-out section which is bent to protect the edge of the PTC element. Barriers which are added to the metal piece forming the first lead can be in the form of walls or dams which protrude from the surface of the first lead. These may be metal pieces which are welded, soldered, or attached to the lead; polymers, e.g. epoxy resins, which are positioned on the lead, and are attached to or cured in place to form the barrier; or ceramic, glass, or paper which are attached to the lead. The barrier may extend the width of the lead, but need not, and, depending on the location of the weld, may be centered on the lead or positioned off-center. The barrier can be formed in or added to the individual lead before attachment to the PTC chip or can be formed in or added to the final device after assembly.

The second electrical lead also comprises three sections: a second attachment portion, a second connection portion, and a second barrier portion which is positioned on the second lead between the second attachment and connection portions. The height of the second barrier portion y may be the same as or different from x, but generally is preferably at least 0.5 t, particularly at least 0.8 t, preferably at least t. The second barrier portion extends from the second lead toward the first electrode. Depending on the application and type of substrate, the second barrier portion may be the same as or different from the first barrier portion.

The first and second leads are generally oriented axially from one another, but for some applications, they may be positioned at 90° to one another, and for other applications, they may be parallel to one another.

Additional protection from weld splatter may be achieved by the use of an electrically insulating layer, e.g. a tape, wrapped around at least the first attachment portion of the first lead (and any exposed section of the first electrode if it is not completely covered by the first lead), or, preferably, wrapped around at least the first attachment portion and some or all of the first barrier portion of the first lead.

Devices of the invention are particularly useful when making attachment to a battery, or to a battery pack containing one or more batteries (i.e. cells), to form a battery assembly. The first and second leads are used to connect the device from a first terminal on one battery to another second terminal on a second battery in the pack. Batteries based on any type of battery chemistry may be used, including nickel cadmium batteries, nickel metal hydride batteries, lithium ion batteries, lithium polymer batteries, and primary lithium batteries. Alternatively, the connection can be to one battery and another substrate, e.g. a circuit board, or to a substrate alone.

While the devices of the invention often have electrical leads in the form of straps and are designated “strap devices”, other types of PTC circuit protection devices can also benefit from the invention. For example, devices in which metal terminals, e.g. steel, brass or copper, are attached by means of solder or welding to a chip in order to control the heat dissipation of the device, may be used. Such devices are disclosed in U.S. Pat. Nos. 5,089,801 and 5,436,609 (both Chan et al.), the disclosures of which are incorporated herein by reference.

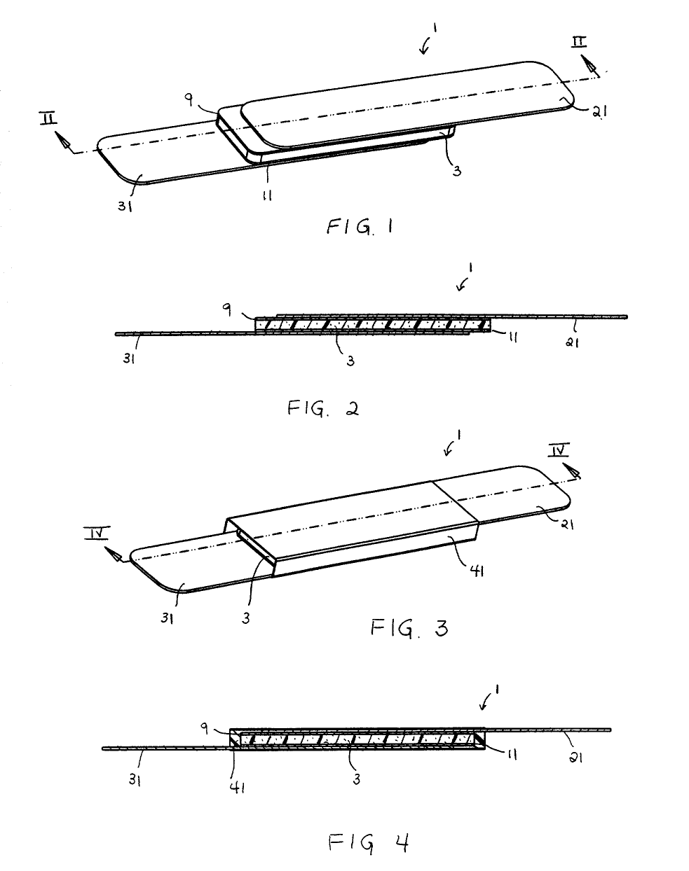

The invention is illustrated by the drawings in which FIG. 1 shows in perspective view a conventional circuit protection device 1. FIG. 2 shows the device of FIG. 1 in cross-section along line II-II. PTC element 3 is sandwiched between first and second electrodes 9, 11. First and second electrical leads 21, 31 are attached to first electrode 9 and second electrode 11, respectively, by means of solder or conductive adhesive (not shown).

FIG. 3, in perspective view, and FIG. 4, in cross-section, show conventional device 1 which is surrounded by insulating layer 41, e.g. a polymeric tape, which can be used for environmental protection or marking purposes.

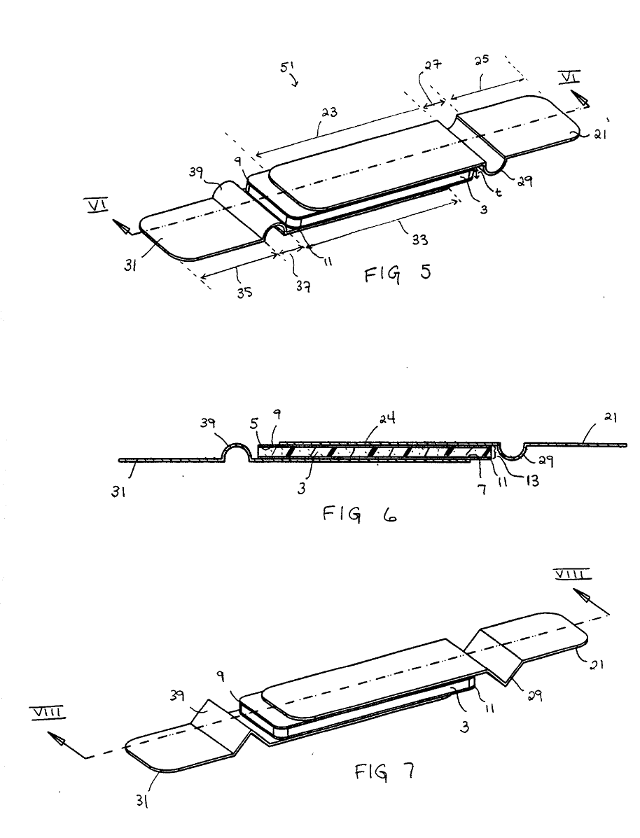

FIG. 5 shows in perspective view a circuit protection device of the invention 51; FIG. 6 shows device 51 along line VI-VI of FIG. 5. PTC element 3 is sandwiched between first and second electrodes 9, 11, with first electrode 9 attached to first major surface 5 and second electrode 11 attached to second major surface 7. PTC element 3 and first and second electrodes 9, 11 combine to form chip 13. First electrical lead 21 is physically and electrically connected to first electrode 9 by means of solder, conductive adhesive, or other appropriate material (not shown). First lead 21 has three sections: first attachment portion 23 which has an attachment surface 24 which is connected to first electrode 9; first connection portion 25 to which a battery terminal or other substrate is attached, e.g. by welding; and first barrier portion 27 which lies between first attachment and connection portions 23 and 25. As shown in FIGS. 5 and 6, first barrier 29 is in the form of a rounded indentation or dimple in first lead 21, which extends away from the plane of first lead 21 toward second electrode 11. Second electrical lead 31 is symmetrical to first lead 21, and is connected to second electrode 11. Second lead 31 also has three sections: second attachment portion 33 which has an attachment surface 34 which is connected to second electrode 11; second connection portion 35 to which a battery terminal or other substrate is attached, e.g. by welding; and second barrier portion 37 which lies between second attachment and connection portions 33 and 35. As shown, second barrier 39 has the same shape as first barrier 29, but extends from the plane of second lead 31 toward first electrode 9.

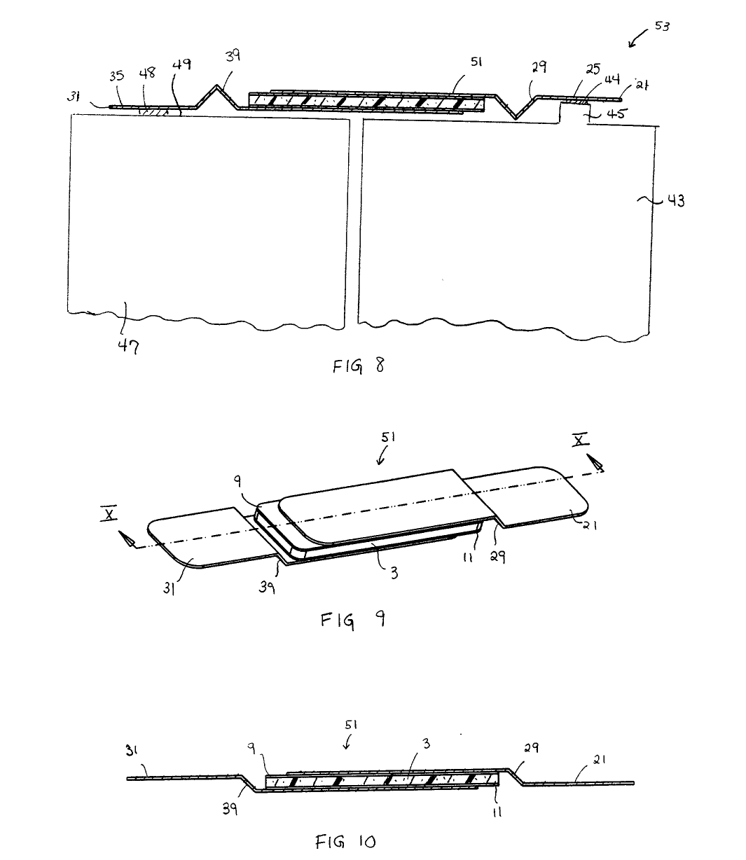

FIGS. 7 to 12 show alternative designs for devices of the invention. In FIG. 7, first and second barrier portions 27, 37 have first and second barriers 29, 39 in the shape of a notch. FIG. 8 shows this device in cross-section along line VIII-VIII of FIG. 7, but in addition shows the connection of first battery 43 to first connection portion 25 via first weld 44 to first battery terminal 45 (which is a button terminal) and of second battery 47 to second connection portion 35 via second weld 48 to second battery terminal 49 (which is a flat terminal). The connection of device 51 to batteries 43 and 47 forms battery assembly 53.

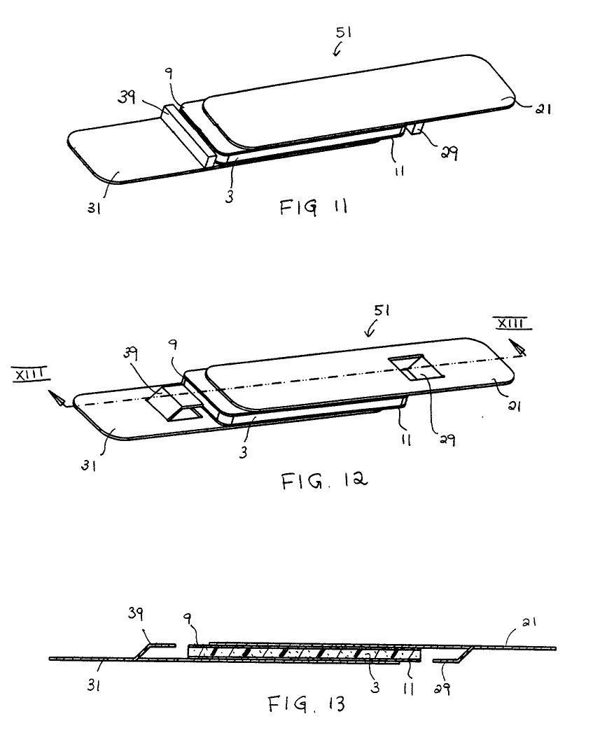

FIG. 9 is a device in which the barrier portion on first and second leads 21, 31 is created by bending the leads. FIG. 10 shows this device in cross-section along line X-X of FIG. 9. In FIG. 11, the first and second barriers 29, 39 are in the form of wall or dam applied to or formed as part of first and second leads 21, 31, respectively. FIG. 12 shows in perspective, and FIG. 13 in cross-section, a device in which first and second barriers 29, 39 are raised cut-outs, prepared by stamping or otherwise cutting the first and second leads.

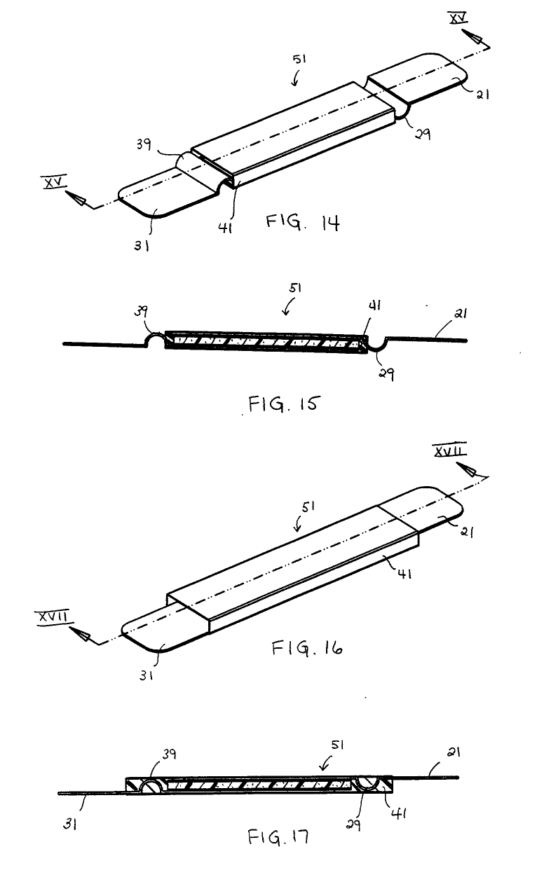

FIGS. 14 and 16 show perspective views and FIGS. 15 and 17 show cross-sections of device 51 of FIG. 5, which has been wrapped with insulating layer 41. Insulating layer 51, in the form of a tape, can cover all parts of the first and second leads (and the underlying chip 13) except the barrier and connection portions (as shown in FIGS. 14 and 15) or all parts except the connection portion (as shown in FIGS. 16 and 17).

It will be understood that the above-described arrangements of apparatus are merely illustrative of applications of the principles of this invention and many other embodiments and modifications may be made without departing from the spirit and scope of the invention as defined in the claims.

What is claimed is:

1. A circuit protection device comprising
(1) a laminar PTC resistive element having first and second major surfaces and a thickness t;
(2) a first electrode attached to the first surface of the PTC element;
(3) a second electrode attached to the second surface of the PTC element; and
(4) a first electrical lead comprising
(a) a first attachment portion having an attachment surface which is attached to the first electrode,
(b) a first connection portion which can be connected to an electrical circuit and is spaced away from the PTC element, and
(c) a first barrier portion which (i) is positioned on the first lead between the first attachment and first connection portions, (ii) extends toward the second electrode, and (iii) has a height x.

2. A device according to claim 1 which further comprises
(5) a second electrical lead comprising
(a) a second attachment portion having an attachment surface which is attached to the second electrode,
(b) a second connection portion which can be connected to an electrical circuit and is spaced away from the PTC element, and
(c) a second barrier portion which (i) is positioned on the second lead between the second attachment and second connection portions, (ii) extends toward the first electrode, and (iii) has a height y.

3. A device according to claim 1 wherein first barrier height x is at least as great as thickness t.

4. A device according to claim 2 wherein first barrier height x and second barrier height y are at least as great as 0.5 t.

5. A device according to claim 2 wherein the first and second leads comprise metal.

6. A device according to claim 2 wherein the first and second electrical leads are oriented axially.

7. A device according to claim 2 wherein the first and second leads are oriented at a 90° angle to one another.

8. A device according to claim 1 wherein the PTC element comprises a conductive polymer composition.

9. A device according to claim 1 wherein the first barrier portion comprises an indentation, notch, or bend in the first lead.

10. A device according to claim 1 wherein the first barrier portion comprises a raised cutout.

11. A device according to claim 1 wherein the first barrier portion comprises a wall.

12. A device according to claim 11 wherein the wall comprises a metallic or polymeric material.

13. A device according to claim 2 which further comprises an insulating layer which covers the first attachment portion, the second attachment portion, any section of the first electrode extending beyond the first attachment portion, and any section of the second electrode extending beyond the second attachment portion.

14. A device according to claim 13 wherein the insulating layer comprises a tape.

15. A device according to claim 2 which further comprises an insulating layer which covers the first and second attachment portions, the first and second barrier portions, any section of the first electrode extending beyond the first attachment portion, and any section of the second electrode extending beyond the second attachment portion.

16. A device according to claim 15 wherein the insulating layer comprises a tape.

17. A circuit protection device comprising
(1) a laminar PTC resistive element having first and second major surfaces and a thickness t;
(2) a first electrode attached to the first surface of the PTC element;
(3) a second electrode attached to the second surface of the PTC element;
(4) a first electrical lead comprising
(a) a first attachment portion having an attachment surface which is attached to the first electrode,
(b) a first connection portion which can be connected to an electrical circuit and is spaced away from the PTC element, and
(c) a first barrier portion which (i) is positioned on the first lead between the first attachment and first connection portions, and (ii) extends toward the second electrode; and
(5) a second electrical lead comprising
(a) a second attachment portion having an attachment surface which is attached to the second electrode,
(b) a second connection portion which can be connected to an electrical circuit and is spaced away from the PTC element, and
(c) a second barrier portion which (i) is positioned on the second lead between the second attachment and second connection portions, and (ii) extends toward the first electrode,
said first barrier portion being designed to block weld splatter between the first connection portion and the PTC element and said second barrier portion being designed to block weld splatter between the second connection portion and the PTC element.

18. A battery assembly comprising
(A) a circuit protection device comprising
(1) a laminar PTC resistive element having first and second major surfaces and a thickness t;
(2) a first electrode attached to the first surface of the PTC element;
(3) a second electrode attached to the second surface of the PTC element; and
(4) a first electrical lead comprising
(a) a first attachment portion having an attachment surface which is attached to the first electrode,
(b) a first connection portion which can be connected to an electrical circuit and is spaced away from the PTC element, and
(c) a first barrier portion which (i) is positioned on the first lead between the first attachment and first connection portions, (ii) extends toward the second electrode, and (iii) has a height x, and
(B) a battery comprising a terminal, said terminal being welded to the first connection portion.
